(19) United States
(12) Patent Application Publication
(10) Pub. No.: US 2008/0230182 A1
(43) Pub. Date: Sep. 25, 2008

(54) CD label applicator and CD label paper

(75) Inventor: Chin Ying Hsieh, Taipei (TW)

Correspondence Address: BACON & THOMAS, PLLC, 625 SLATERS LANE, FOURTH FLOOR, ALEXANDRIA, VA, 22314-1176, US

(73) Assignee: Ching-Ching HUANG; Chin Ying HSIEH, Taipei (TW)

(21) Appl. No.: 11/892,200

(22) Filed: Aug. 21, 2007

(30) Foreign Application Priority Data
Mar. 21, 2007 (TW) 096204582

(51) Int. Cl. B29C 63/00; G09F 3/10

(52) U.S. Cl. 156/391; 156/556; 156/580

(57) ABSTRACT

The present invention provides a CD label applicator. It comprises a lower plate and an upper plate being linked each other with one side thereof. A round sunk area is formed on the middle of the lower plate to accommodate a CD; three posts are formed at appropriate points along peripheral of the lower plate. A layer of removable adhesive with anular shape is attached on the middle of the upper plate; three holes are formed at appropriate points along peripheral of the upper plate. When the upper plate covers the lower plate, the removable adhesive with anular shape just coincides with the round sunk area, and the three holes just sleeve on the the three posts respectively.

The present invention also provides a CD label paper, three notches are formed at appropriate points along peripheral of the CD label paper to coincide respectively with three posts on the lower plate of the CD label applicator.

### FIELD OF THE INVENTION

The present invention relates to a CD label applicator and a CD label paper, and more particularly to a CD label applicator with annular removeable adhesive and a CD label paper with notches for alignment.

### BACKGROUND OF THE INVENTION

Conventional CD label applicator is shown in FIG. 1, a round case 1 has a pressable unit 11 on the middle top, the pressable unit 11 can be pressed into the round case 1. The top area of the round case 1 is the same as a CD's.

When a CD label 2 is to be attached on a CD 3, a hole 21 in the middle of the CD label 2 is sleeved around the pressable unit 11 so as to spread the CD label 2 on the round case 1, a layer of adhesive 22 on one side of the CD label 2 faces up; and then a hole 31 in the middle of the CD 3 is sleeved around a top portion 12 of the pressable unit 11, the top portion 12 of the pressable unit 11 is then pressed into the round case 1 so that the CD 3 is attached on the layer of adhesive 22; take out the CD 3, the CD label 2 is attached on the CD 3.

Since the layer of adhesive 22 tends to stick the hand and CD label 2 tends to roll up during operation, it is very difficult to attach the CD 3 with the layer of adhesive 22 of the CD label 2.

### SUMMARY OF THE INVENTION

The object of the present invention is to provide a CD label applicator, it comprises a lower plate and an upper plate linked each other with one side thereof. A round sunk area is formed on the middle of the lower plate to accommodate a CD; three posts are formed at appropriate points along peripheral of the lower plate. A layer of removable adhesive with anular shape is attached on the middle of the upper plate; three holes are formed at appropriate points along peripheral of the upper plate. When the upper plate covers the lower plate, the removable adhesive with anular shape just coincide with the round sunk area, and the three holes just sleeve on the the three posts respectively.

The present invention also provides a CD label paper. A CD label is attached on the CD label paper by a layer of adhesive on the CD label, but the CD label can be peeled off from the CD label paper. Three notches are formed at appropriate points along peripheral of the CD label paper to coincide respectively with the three posts on the lower plate of the CD label applicator.

### BRIEF DESCRIPTION OF THE DRAWING

FIG. 1 shows schematically a conventional CD label applicator.

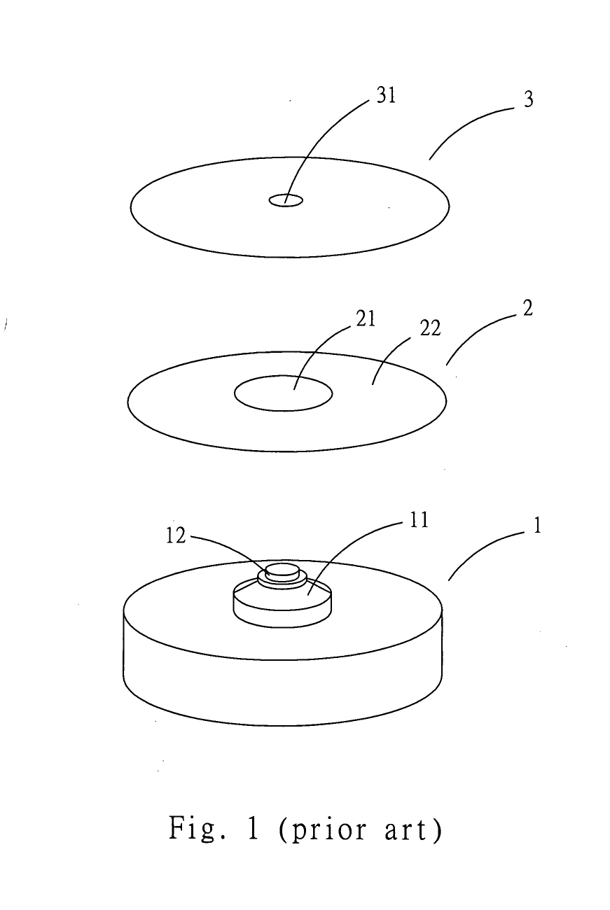

FIG. 2 shows schematically a CD label applicator according to the present invention.

FIG. 3 shows schematically a CD label paper according to the present invention.

FIG. 4 shows schematically a lower plate and an upper plate of the CD label applicator according to the present invention.

### DETAILED DESCRIPTION OF THE PREFERRED EMBODIMENT

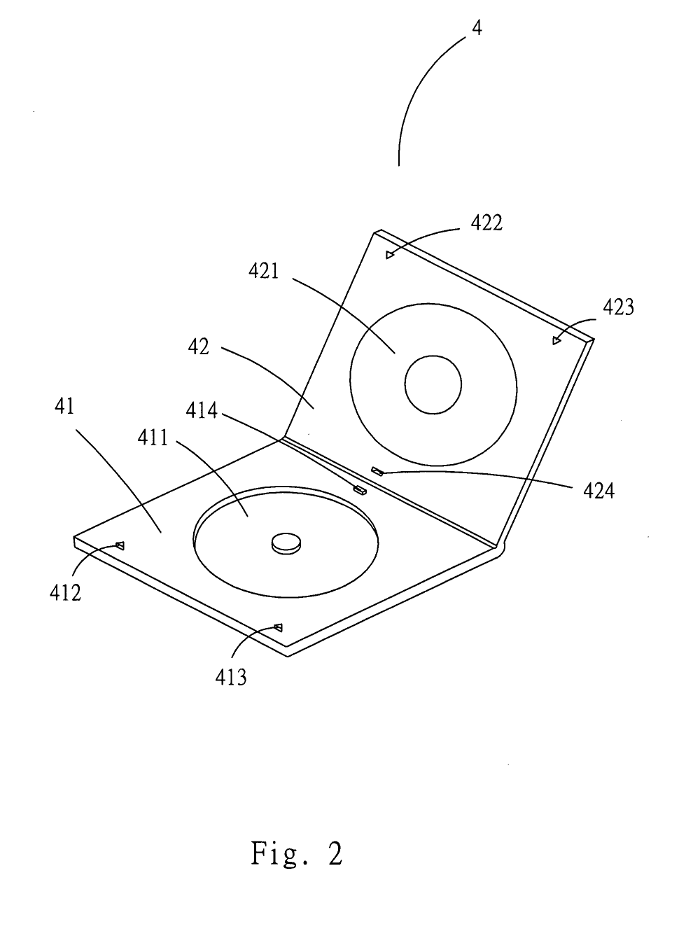

Referring to FIG. 2, a CD label applicator 4 according to the present invention is shown. The CD label applicator 4 comprises two square thin plates made of plastic material with thickness about 3 mm. The lower plate 41 and the upper plate 42 are linked each other with one side thereof. A round sunk area 411 is formed on the middle of the lower plate 41 to accommodate a CD; three posts 412, 413, 414 are formed at appropriate points along peripheral of the lower plate 41. The depth of the round sunk area 411 is about 2 mm, the height of the posts 412, 413, 414 is about 1 mm. A layer of removable adhesive 421 with anular shape is attached on the middle of the upper plate 42, the annular shape thereof is the same as a CD label, and the thickness of the removable adhesive 421 is only 0.1 mm. Three holes 422, 423, 424 are formed at appropriate points along the peripheral of the upper plate 42. When the upper plate 42 covers the lower plate 41, the removable adhesive 421 with anular shape just coincides with the round sunk area 411, and the three holes 422, 423, 424 just sleeve on the the three posts 412, 413, 414 respectively.

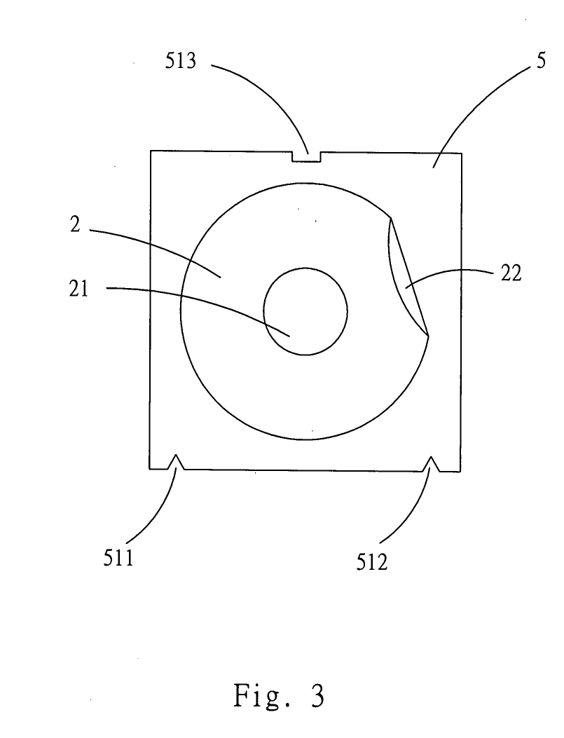

The present invention also provides a CD label paper 5, as shown in FIG. 3. The CD label paper 5 is square in shape with a round CD label 2 to be attached on the CD label paper 5. The upper right corner of the CD label 2 is lifted to show a layer of adhesive 22 on the back of the CD label 2. The CD label 2 can be peeled off from the CD label paper 5. Actually the CD label 2 is flat attached to the CD label paper 5. Three notches 511, 512, 513 are formed at appropriate points along peripheral of the CD label paper 5 to coincide respectively with three posts 412, 413, 414 on the lower plate 41 of the CD label applicator 4.

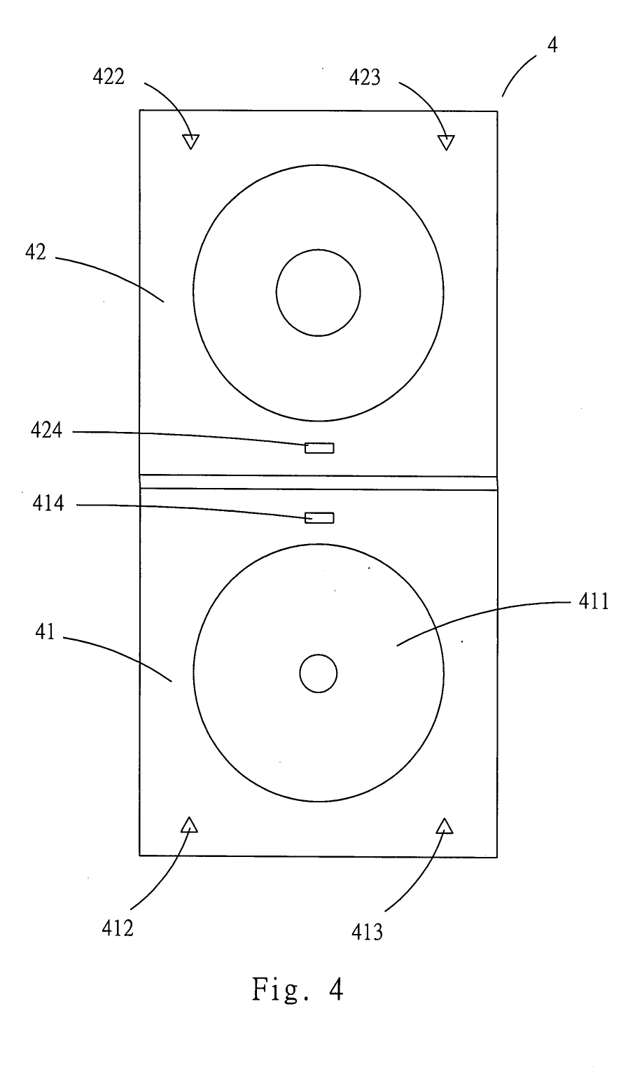

Referring to FIG. 4, the lower plate 41 and the upper plate 42 of the CD label applicator 4 are spread horizontally, and let a CD 3 to be placed in the round sunk area 411 of the lower plate 41, then put a CD label paper 5 on the lower plate 41 (CD label 2 is attached on the CD label paper 5), so that three notches 511, 512, 513 coincide respectively with three posts 412, 413, 414 on the lower plate 41. Thereafter the upper plate 42 is turned over to cover the lower plate 41 so that the three holes 422, 423, 424 just sleeve on the the three posts 412, 413, 414 respectively, and the removable adhesive 421 with anular shape sticks the CD label 2. Then the upper plate 42 is lifted to carry the CD label paper 5, peel off the CD label paper 5, the CD label 2 remains attaching on the upper plate 42.

Thereafter the upper plate 42 is turned over again to cover the lower plate 41 so that the three holes 422, 423, 424 just sleeve on the the three posts 412, 413, 414 respectively, and the CD label 2 is attached by the adhesive thereof on the CD 3. Then the upper plate 42 is lifted to carry the CD 3, peel off the CD 3. Since the removable adhesive 421 is not strong enough, the CD label 2 will leave the upper plate 42 and stay on the CD 3.

The scope of the present invention depends upon the following claims, and is not limited by the above embodiments.

What is claimed is:

1. A CD label applicator, comprising a lower plate and an upper plate being linked each other with one side thereof; a round sunk area is formed on the middle of the lower plate to accommodate a CD; a layer of removable adhesive with anular shape is attached on the middle of the upper plate; when the upper plate covers the lower plate, the removable adhesive with anular shape just coincides with the round sunk area.

2. The CD label applicator according to claim 1, wherein three posts are formed at appropriate points along peripheral of the lower plate; three holes are formed at appropriate points along peripheral of the upper plate; when the upper plate covers the lower plate, the three holes just sleeve on the the three posts respectively.

3. A CD label paper, a CD label is attached on the CD label paper by a layer of adhesive on one side of the CD label, while the CD label can be peeled off from the CD label paper; three notches are formed at appropriate points along peripheral of the CD label paper to coincide respectively with three posts on the lower plate of the CD label applicator in claim 2.
